(19) United States
(12) Patent Application Publication
(10) Pub. No.: US 2012/0272317 A1
(43) Pub. Date: Oct. 25, 2012

(54) SYSTEM AND METHOD FOR DETECTING INFECTIOUS WEB CONTENT

(75) Inventors: Jonathan A. Rubin, Bedford, MA (US); John H. Lowry, Pepperell, MA (US)

(73) Assignee: Raytheon BBN Technologies Corp, Cambridge, MA (US)

(21) Appl. No.: 13/093,595

(22) Filed: Apr. 25, 2011

(51) Int. Cl. G06F 11/00; G06F 21/00

(52) U.S. Cl. 726/23

(57) ABSTRACT

Systems and methods are disclosed herein for detecting a threat to a computing device. The system includes a server and a computing device in communication with the server and configured to browse the Internet. The server receives data indicating a configuration parameter of the computing device and executes an emulation of the computing device that replicates the configuration parameter. The server also receives data relating to the computing device's browsing behavior and replicates the browsing behavior on the emulation. Upon detecting an undesired modification to the emulation of the computing device caused by the replicated browsing behavior, the server automatically generates and outputs an alert related to the undesired modification and related browsing behavior.

### FIELD OF THE INVENTION

In general, the invention relates to a computerized system and method for detecting undesired Internet content. More specifically, the invention relates to a computerized system and method for executing an emulation on a server that replicates the environment and behavior of a computing device for determining if the computing device has or may receive any undesired content.

### BACKGROUND OF THE INVENTION

The presence of malicious, defective, or otherwise unwanted content on the Internet poses threats to the functionality and security of computers and computer networks. Malicious software or “malware” that Internet users can be exposed to includes computer viruses, worms, Trojan horses, spyware, dishonest adware, scareware, crimeware, and rootkits. In addition to malware, Internet users are exposed to defective software which has harmful or undesirable bugs. Furthermore, Internet users are exposed to Grayware, which includes spyware, adware, joke programs, remote access tools. Grayware, while not as harmful as malware, still impacts the performance of a computing device or user experience and is undesirable.

Many security measures, including browsing in various forms of sandboxed environments and performing antivirus scanning, are available for protecting computing devices and computer networks and/or removing undesired content from devices on a network. However, current methods for detecting undesired content that run as a user is browsing the Internet consume processing and memory resources, the use of which negatively impacts the performance of the computing device and the user's experience. Furthermore, such techniques are difficult to administer and maintain over a large network.

One known security device implemented separately from a user's computing device is a client honeypot, which actively searches the web to find infectious content. However, client honeypots do not replicate the actual behavior of a user, so they do not detect undesired content before or as it begins affecting a computer or network, and some content is inaccessible. In particular, client honeypots may not be able to access the same websites or download the same files as an active user with passwords or privileges to access restricted material.

Other computing device and network security measures include email scanning methods. Email scanning can be done at a server, rather than a user's computer, and is applied to actual files received by a user. However, email scanning creates a time lag between when an email arrives at the email scanner and when it can be delivered to its recipient. While such a delay is tolerable for email, users will not tolerate a delay for each web site they browse or file they try to download from the Internet.

### SUMMARY OF THE INVENTION

There is therefore a need in the art for a system and method for fast detection of infectious web content accessed by a user with less impact on the quality of a user's browsing experience than with previous methods. An emulation running on a server in communication with a computing device with which the user is browsing the Internet can be used to solve this problem. Using an emulation can also be more effective at detecting undesired modifications than previous techniques, since it is easier to detect unwanted behavior or changes to an emulation than a physical machine. If the emulation is running only a web browser, rather than running multiple programs at once as is typical on a personal computing device, the security software can be certain about the source of content. Furthermore, specialized software on the server can be designed to be more adept in detecting unwanted content or behaviors than software monitoring a personal computer typically can be.

Such systems and methods are particularly applicable for a network of multiple computing devices. On a network, it is more efficient to dedicate the resources of a server to detecting undesired content than to run resource-consuming and less accurate monitoring software on individual computing devices. The server can be configured to identify potential threats before they infect other networked computing devices, or even before infecting a single computing device on the network. The server can use a look-ahead method for detecting potentially malicious web content before the user browses the content. Also, the server can also identify content which is not harmful to the device browsing the content, but may affect a networked device with different configurations.

Accordingly, systems and methods are disclosed herein for detecting a threat to a computing device. The system includes a server and a computing device in communication with the server and configured to browse the Internet. The server receives data indicating a configuration parameter of the computing device and executes an emulation of the computing device that replicates the configuration parameter. The server also receives data relating to the computing device's browsing behavior and replicates the browsing behavior on the emulation. Upon detecting an undesired modification to the emulation of the computing device caused by the replicated browsing behavior, the server automatically generates and outputs an alert related to the undesired modification and related browsing behavior. The alert may include one of a source IP address of a web page, a URL of a web page, a time the undesired modification was detected, a binary file received by the emulation, an identifier of the undesired modification detected on the emulation, and a configuration of the emulation.

In some embodiments, the emulation is a virtual machine. The server can be further configured to select a virtual machine with appropriate configuration parameters to emulate the computing device. The server may use a web browser that is similar to the browser on the computing device to replicate the browsing behavior.

In certain embodiments, a data store is used to store data related to the replicated browsing behavior. The replicated browsing behavior may include downloading electronic files from a web page; these files may be stored in a data store.

In some embodiments, the server is in communication with a plurality of computing devices on a network. Upon detecting an undesired modification, the server may automatically generate a network policy related to the browsing behavior that caused the undesired modification and apply the policy to the plurality of computing devices. Upon detecting an undesired modification, the server may additionally or alternatively initiate at least one of restoring the computing device to a previous setting, blocking at least one other computing device from accessing a web page that caused the undesired modification, sending a notification to a system administrator, and sending a notification to network users.

The server may simultaneously execute multiple emulations with different configuration parameters used by different computing devices on the network. In this case, the server executes a first emulation of a first computing device and a second emulation of a second computing device, wherein a configuration parameter of the first emulation is different from a configuration parameter of the second emulation. The server receives data related to browsing behavior of the first computing device and replicates it on the second emulation. The server may then detect an undesired modification to the second emulation caused by the replicated browsing behavior.

The system may be configured for performing look-ahead analysis. This involves identifying a link to digital content on a first web page that the computing device has not accessed and activating the link on the emulation. If the server detects an undesired modification to the emulation caused by the activation of the link, it automatically generates an alert containing data related to the link. The server may also prevent the computing device from activating the link.

In some embodiments, the computing device is a mobile device. The mobile device can be configured to automatically forward data indicative of browsing behavior to the server. In other embodiments, the computing device is connected to a network through an intermediate network device in communication with the server, and the server receives the data related to browsing behavior of the computing device via the intermediate network device.

In some embodiments, the server has an Internet connection, and the emulation browses web pages over the Internet connection. In other embodiments, the emulation receives cached files from the computing device, and the emulation browses the cached files.

According to another aspect, the invention relates to computerized methods for carrying out the functionalities described above. According to another aspect, the invention relates to non-transitory computer readable medium having stored therein instructions for causing a processor to carry out the functionalities described above.

### BRIEF DESCRIPTION OF THE DRAWINGS

FIG. 1 is an architectural model of a system for detecting a threat to a computing device, according to an illustrative embodiment of the invention.

FIG. 2 is an architectural model of a system for detecting a threat to one or more computing devices in a network, according to an illustrative embodiment of the invention

FIG. 3 is a flowchart for a method for detecting a threat to a computing device, according to an illustrative embodiment of the invention.

FIG. 4 is an architectural model of a system for detecting a threat to one or more mobile devices in a network, according to an illustrative embodiment of the invention.

### DESCRIPTION OF CERTAIN ILLUSTRATIVE EMBODIMENTS

To provide an overall understanding of the invention, certain illustrative embodiments will now be described, including systems and methods for detecting infectious web content. However, it will be understood by one of ordinary skill in the art that the systems and methods described herein may be adapted and modified as is appropriate for the application being addressed and that the systems and methods described herein may be employed in other suitable applications, and that such other additions and modifications will not depart from the scope thereof.

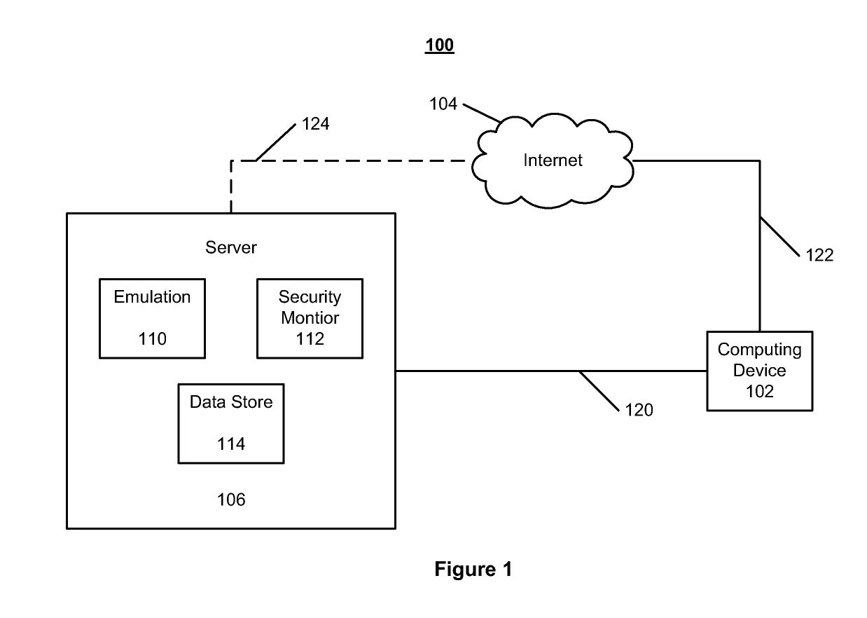

FIG. 1 is an architectural model of a system 100 for detecting a threat to a computing device 102. The computing device 102 is connected to the Internet 104 over Internet connection 122. The computing device 102 is also connected to a server 106 through a local area connection 120. When the computing device 102 is browsing the Internet, it is vulnerable to malicious or otherwise unwanted content from other users or from content browsed by the user. The server 106 is configured to replicate the web browsing behavior of the computing device 102 in order to detect the presence of unwanted content or, in some cases, detect potentially unwanted content before it reaches the computing device 102.

The server 106 executes an emulation 110 of the computing device 102 and, using security monitor 112, detects undesired content or an effect of undesired content on the emulation 110. The server also includes a data store 114 for storing data related to the browsing behavior of the computing device 102 and/or emulation 110, the configurations of the computing device 102 and/or emulation 110, the effects of content on the emulation 110, and any other data relevant for determining the source and nature of content on the emulation 110.

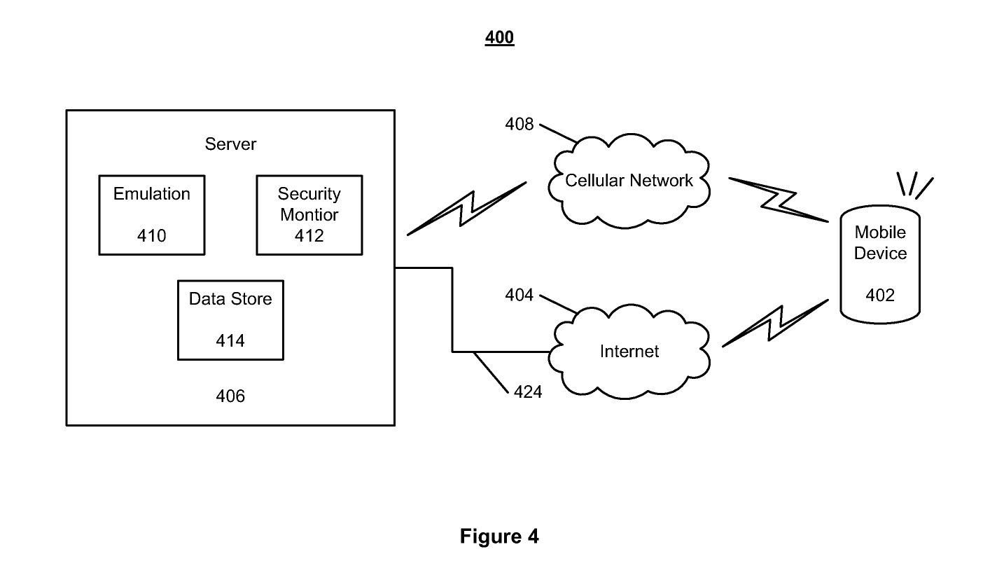

The computing device 102 may be any computing device known in the art including a personal computer, a laptop computer, a notebook, a netbook, a tablet computer, a personal digital assistant, a mobile device, or other computing devices capable of connecting to the Internet. The computing device 102 may be a mobile device, such as a cell phone, smart phone, or similar handheld device; such a system is described in greater detail in relation to FIG. 4. The computing device 102 may have a wired connection to the Internet, such as dial-up or broadband (e.g. DSL, cable, DS1, etc.), or a wireless connection, such as Wi-Fi, satellite, 3G/4G, or any other wired or wireless Internet connections. The computing device is also connected to the server 106 through a local area network, implemented using, for example, Ethernet or Wi-Fi. The computing device 102 may be unaware of the server 106. In some implementations, the computing device 102 requires no additional configurations or software for the server 106 to receive the needed data needed from the computing device 102 to replicate its browsing behavior.

The server 106 includes software for executing the emulation 110 of the computing device 102, so that the emulation 110 replicates configuration parameters of the computing device 102. Configurations that the server 106 replicates in the emulation 110 include the central processing unit (CPU), the operating system, the web browser, and the memory subsystem. The server 106 may also be configured to emulate hardware, such as input/output devices, used by the computing device 102.

To create a replicated computing environment, the server 106 stores or receives configurations of the computing device 102. The server 106 can access configuration parameters of the computing 102 device using device fingerprinting techniques known in the art. Configuration parameters available through fingerprinting include, but are not limited to, TCP/IP configuration, OS fingerprint, IEEE 802.11 (wireless) settings, clock skew, MAC address, and other serial numbers. The web browser configuration can similarly be fingerprinted. For example, panopticlick.eff.org shows an implementation of web browser fingerprinting that can determine configuration parameters such as user agent, plugin details, time zone, screen size and color depth, fonts, and cookie information. The web browser fingerprint can also include the web browser name and version information. While most of the aforementioned configuration parameters can be gathered through passive fingerprinting, i.e. fingerprinting without querying the computing device, the server can also query the computing device which returns additional configuration parameters. Alternatively, the computing device may be configured to automatically send some or all of these and/or other configuration parameters to the server. In some implementations, the server 106 receives additional configuration parameters relating to information of additional software (e.g. name and version information), such as word processing, email, audio/video players, or other applications for opening files downloaded from the Internet.

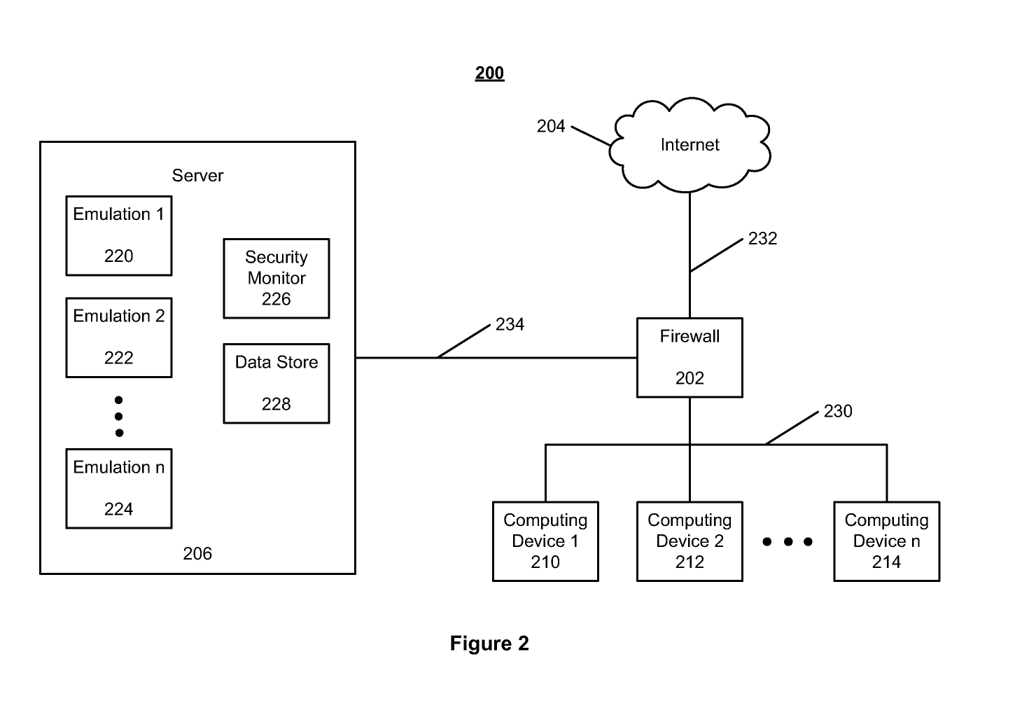

With the configuration parameters, the server 106 executes, or “stands up”, the emulation 110. The emulation may be a virtual machine, which is a software implementation of a physical machine that executes programs like the physical machine. The server 106 provides a software layer, i.e. a virtual machine monitor or hypervisor, to provide the virtualization. The hypervisor may or may not run on an operating system. The emulation 110 may be a full virtualization, including the full instruction set, input/output operations, interrupts, memory access, and anything else accessed by software, particularly the web browser, on the computing device. In some implementations, multiple emulations are present on the server 106. If the computing device 102 has multiple browsers or browsing windows opened, the server 106 may execute an independent emulation for each browser or browsing window. If the server 106 is connected to a network of computing devices, it may execute a separate emulation for each computing device. The architecture for use in a computer network with multiple computing devices is described in relation to FIG. 2.

In some embodiments, the emulation 110 browses the Internet through Internet connection 124. In this case, the server 106 receives information about the browsing behavior of the computing device 102, e.g. web addresses that the computing device 102 has visited and files that the computing device 102 has downloaded, and causes the emulation 110 to browse the same websites and/or download the same files as the computing device 102. In other embodiments not requiring the Internet connection 124, the emulation 110 is passed files from the computing device, e.g. web pages and downloaded files, and loads them using a web browser and/or other software.

In addition to the emulation 110, the server 106 also runs security monitoring software 112 that analyzes the emulation 110. The security monitoring software 112 determines if web browsing on the emulation 110 has introduced any undesired content or behavior onto the emulation 110. The security monitoring software 112 may perform malware detection or other analysis known in the art to determine if the emulation has been affected in an unexpected or undesirable way as a result of browsing behavior. The security monitor 112 may use signature based detection to identify known malware, heuristic detection to identify new malware or unknown variations of known malware example, or behavioral detection to identify unexpected behaviors of the emulation 110. In some implementations, the security monitor 112 compares the current operating state of the emulation 110 to past states to detect if there has been a modification. A combination of these and any other techniques known in the art may be utilized.

The security monitoring software is also configured to create an alert if it detects an undesired modification to the emulation 110. The alert contains an identifier (e.g. IP address and/or URL) of the source web page that caused the undesired modification, the file downloaded by the emulation 110, and a report detailing the behaviors or modifications of the emulation 110. The alert may also contain a time that the undesired modification was detected, a binary file received by the emulation 110, and/or a configuration parameter of the emulation 110. The alert can be delivered to the user of the computing device 102, a system administrator, a network security expert, the manufacturer or administrator of the server 106, a virus detection service, or any other interested party. The alert may be sent through the Internet connection 124 or local area network 120. The alert can be formatted as one or more of a message or pop-up in the computing device's web browser, an email, a text message, an audio warning, a message stored on the server or another location, or through other means. In addition to creating and sending an alert, the security monitor 112 may initiate an action to protect the computing device 102. Protective actions include restoring the computing device to a previous setting, blocking the computing device from accessing a web page or file linked from the web page that caused the undesired modification, and blocking future access to the web page. The nature of the undesired modification may determine which, if any, protective actions should be taken.

While the security monitor 112 is shown as separate from the emulation 110, in other implementations, the security monitor 112 is running on the emulation 110. In other implementations, security monitoring is performed by both software running on the emulation 110 and software running on the server 106.

In addition to a web browser, the emulation 110 may run software used by the computing device 102 for opening a file downloaded from the Internet so that the security monitor 112 can analyze if the downloaded file causes any undesired modification to the emulation 110. Alternatively, a separate emulation may be passed a downloaded file to open. This would allow the security monitor 112 to distinguish whether browsing behavior or a downloaded file caused an undesired modification.

As shown in system 100, the server 106 also includes a data store 114. The data store 114 stores data related to the browsing behavior of the computing device 102 and/or emulation 110 (e.g. identifiers, such as URLs and file names, of the source web pages and downloaded files), the configuration parameters of the computing device 102 and/or emulation 110, files downloaded by the emulation 110, and information describing the behaviors or modifications to the emulation 110. The data store 114 receives data directly from the emulation 110 or from the security monitor 112, and the data store 114 can be accessed by at least the security monitor 112. The data store 114 may also store information for identifying unwanted files, for example identifiers of known malware. The data store 114 may also store settings or files from the computing device 102 so that, if the computing device 102 experiences an undesired modification, the computing device 102 may be restored to the previous setting.

The data store 114 may be configured as, for example, a relational database, an object-oriented database, an operational data store, a data warehouse, or a schemaless data store. The data store 114 may automatically remove data after a certain amount of time or when the data store 114 becomes full. In some embodiments, the data store 114 may be an external data store that is in communication with the server 106.

FIG. 2 is an architectural model of a system 200 for detecting a threat to networked computing devices 210-214 on local area network 230. The computing devices 210-214 are similar to computing device 102 described above in relation to FIG. 1 and are connected to the Internet 204 over an Internet connection 232 and through a firewall 202. The firewall 202 is also connected to a server 206 through a connection 234. The server 206 is configured to replicate the browsing behavior of the multiple computing devices 210-214 in order to detect the presence of unwanted content on one or more of the computing devices.

The firewall 202 is configured to control transmission between the computing devices 210-214 and the Internet 204. The firewall 202 can be any intermediate network device (e.g. a proxy, a server, a router, etc.). The firewall 202 may be configured to passively watch web traffic and pass-through traffic, or to perform active blocking and/or modifying of web content. The firewall 202 forwards browsing behavior and/or files to the server 206 through connection 234. The server 206 is configured to replicate browsing behavior of m computing devices 210-214 with n emulations 220-224. If the security monitor 226 detects an undesired modification to any of the emulations 220-224, the security monitor 226 may initiate a network policy, some of which may be carried out by the firewall 202, which can deny access to files and web pages. Such actions include blocking the computing devices 210-214 from accessing a web page or file linked from the web page that caused the undesired modification, and blocking future access to the file or web page.

The operation of the server 206 and its components is similar to that of the server 106 described above in relation to FIG. 1, with several additional features. When the security monitor 226 detects an undesired modification, it creates an alert similar to the alert described above in relation to FIG. 1, which also contains an identifier (e.g. IP address or MAC address) of the computing device 220-224 that was affected. If an undesired modification to a computing device may affect the other computing devices on the local area network 230, the affected computing device may be automatically disconnected from the other computing devices.

Different computing devices may run different operating systems (e.g. Windows 7, Linux, Mac OS X) and different web browsers (e.g. Internet Explorer, Firefox, Google Chrome). A single computing device may run multiple operating systems and/or multiple web browsers. The system 200 does not necessarily have a 1:1 correspondence between computing devices 210-214 and emulations 220-224. For example, the server 206 can be configured to execute individual operating systems and/or web browsers used by computing devices 210-214 in separate emulations 220-224 so that their activities can be isolated and analyzed separately. The server 206 may run also a separate security monitor for each of the emulations 220-224.

The server 206 may store a set of common configurations in memory or in the data store 228. When any of the computing devices 210-214 are browsing the Internet, the server 206 may execute all or a subset of the stored configurations and replicate the browsing behavior of each computing device 210-214 on all of a subset of the stored configurations. This allows the security monitor 226 to detect threats posed by web content to computing devices other than the computing device browsing the content.

In some implementations, the server 206 may be replaced by a bank of servers, with emulations 220-224 distributed across several servers. In this implementation, each server in the bank of servers may include an individual security monitor 226 and data store 228. Alternatively, one or more servers may not include a security monitor 226 or data store 228. In other implementations, the data store 228 is an external data store in communication with the servers, and/or the security monitor 226 is on a separate unit in communication with the servers.

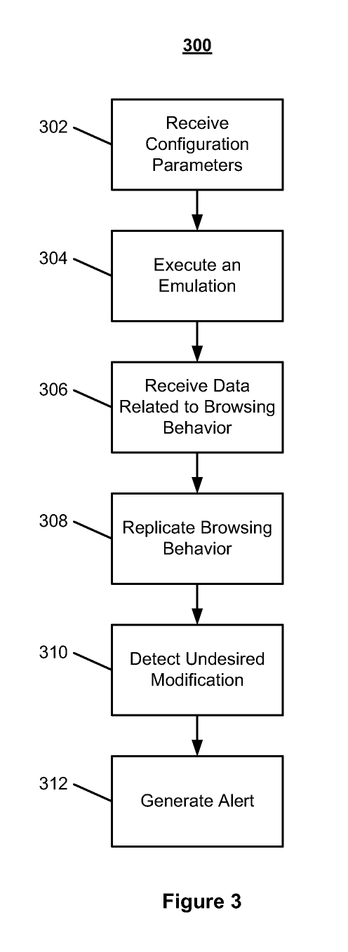

FIG. 3 is a flowchart of a method 300 for detecting a threat to a computing device, according to an illustrative embodiment. The method begins with a server receiving configuration parameters from a computing device (step 302) and executing an emulation of the computing device (step 304). The server also receives data related to browsing behavior of the computing device (step 306) and replicates the browsing behavior (step 308). If the server detects an undesired modification to the emulation (step 310), it generates an alert related to the undesired modification (step 312).

First, a server 106 or 206 receives configuration parameters from a computing device 102 or 210-214 in communication with the server (step 302). The server may store configuration parameters on and access the parameters from a data store 114 or 228; in this case, the server 106 or 206 may only receive an identifier from the computing device 102 or 210-214 and look up the rest of the configuration parameters. In alternative embodiments, the server 106 or 206 does not receive the configuration parameters or execute the emulation until the computing device 102 or 210-214 begins browsing the Internet. As described above with respect to FIG. 1, the configuration parameters can include TCP/IP configuration, OS fingerprint, IEEE 802.11 (wireless) settings, clock skew, MAC address, other serial numbers, user agent, plugin details, time zone, screen size and color depth, fonts, and cookie information, web browser name and version number, and names and version numbers of other applications. The server 106 or 206 then executes an emulation that emulates one or more of these configuration parameters (step 304). If any of the configuration parameters on a computing device change while the emulation is running, the emulation of that computing device should be updated or restarted with the new configuration parameters.

As the computing device 102 or 210-214 browses the Internet, the server 206 receives data (e.g. URLs or files) (step 306) and causes the emulation 110 or 220-224 to replicate the browsing behavior in a web browser, which replicates the web browser of the computing device (step 308). As described in relation to FIG. 1, the emulation may either browse the Internet at URLs received from the computing device, or receive files accessed by the computing device to open in the web browser and/or other software. Unlike some computer security software, the emulation 110 or 220-214 is able to browse and download protected content (e.g. password protected websites), as the user provides the passwords or privileges to access restricted material, or the computing device 102 or 210-214 sends protected web pages and files accessed to the emulation.

In certain embodiments, the emulation 110 or 220-224 does not replicate all browsing behavior of the computing device 102 or 21-0214, but only browsing behavior that is considered suspicious. The data store 114 or 228 may include a list of suspicious websites. Browsing behavior may be considered suspicious if, for example, the user of the computing device 102 tries to access a URL that is on the list of suspicious websites or appears misleading. The computing device 102 may be configured to only send suspicious browsing behavior to the server 106. Alternatively, the security monitor 112 or 226 or the emulation 110 or 220-224 may determine what browsing behavior is suspicious and what browsing behavior to replicate.

As the emulation 110 or 220-224 is emulating the browsing behavior of the computing device 102 or 210-214, it is constantly being monitored by the security monitor 112 or 226 using at least one of behavioral detection techniques, heuristic detection techniques, signature based detection techniques, or any other known methods or techniques known in the art for identifying undesired modifications to a computing device. If the security monitor 112 or 226 detects an undesired modification to the emulation 110 or 220-224 (step 310), it generates an alert related to the modification (step 312). As discussed above in relation to security monitor 112 of FIG. 1, the alert contains an identifier (e.g. IP address and/or URL) of the source web page that caused the undesired modification, an identifier (e.g. IP address and/or MAC address) of the computing device 102 or 210-214 that was affected, the file downloaded by the emulation 110, and a report detailing the behaviors or modifications of the emulation 110.

In certain embodiments, the server 106 or 206 is configured to perform look-ahead security analysis. If a computing device 102 or 210-214 is browsing a web page containing links to other web pages or downloadable files, an emulation 110 or 220-224 accesses the web pages or files before the user of the computing device accesses them. The security monitor 112 or 226 then creates an alert and/or takes a protective action involving the web page or file. In particular, the security monitor 112 or 226 would prevent the computing device or all computing devices on a network from selecting the link or downloading the file.

FIG. 4 is an architectural model of a system 400 for detecting a threat to one or more mobile devices in a network, according to an illustrative embodiment. The system 400 includes a mobile device 402 that is connected to a server 406 through the Internet 404 and/or a cellular network 408.

The mobile device 402 may be a laptop, notebook, tablet computer, palm-sized computer, cell phone, smart phone, or any other electronic device with capability to receive wireless signals. The mobile device 402 has configuration parameters similar to computing device 102, including configuration parameters related to its operating system and applications. The mobile device 402 is connected to the Internet 404. In some embodiments, the mobile device 402 is additionally or alternatively connected to a cellular network 408, which may permit connection to the Internet 404 through a Mobile Web connection. The mobile device 402 can view content and download files through the Internet connection 404 and/or cellular network connection 408. The web browser of the mobile device 402 or its operation system may be configured to automatically forward data indicative of browsing behavior to the server 406 over the cellular network 408 or Internet connection 404.

The server 406 and its components emulation 410, security monitor 412, and data store 414 are similar to the server 102, emulation 110, security monitor 112, and data store 114, respectively, described above in relation to FIG. 1. The server 406 may be further configured for communicating over the cellular network 408. The server 406 is capable of emulating operating systems and additional software used by a mobile device, which may be different from the software running on computing device 102.

In addition to the alerts and actions described above in relation to FIG. 1, the security monitor 412 may take other actions more suitable for a mobile device 402 than a general computing device 102. For example, the security monitor 412 may lock or erase the memory of the mobile device 402 if an undesired modification is detected on the mobile device 402. Alternatively or additionally, the security monitor 412 may send an alert text message to the mobile device 402. If a protective action (e.g. blocking access to the webpage or file) is taken on the mobile device 402, similar action may be taken on related mobile devices, for example, mobile devices on the same payment plan as mobile device 402, mobile devices associated with the same business or other entity as mobile device 402, or mobile devices on the same network as mobile device 402.

While preferable embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A system for detecting an undesired modification to a computing device comprising:
a computing device configured to browse the Internet; and
a server configured for:
receiving data indicative of a configuration parameter of the computing device;
executing an emulation of the computing device, wherein the emulation emulates the configuration parameter of the computing device;
receiving data related to browsing behavior of the computing device;
replicating the browsing behavior of the computing device on the emulation of the computing device;
detecting an undesired modification to the emulation of the computing device caused by the replicated browsing behavior; and
automatically generating and outputting, upon detecting an undesired modification, an alert containing data related to the undesired modification and related browsing behavior.

2. The system of claim 1, wherein the emulation comprises a virtual machine.

3. The system of claim 2, wherein the server is further configured for selecting a virtual machine with appropriate configuration parameters for emulating the computing device.

4. The system of claim 1, wherein the emulation replicates the browsing behavior of the computing device using a web browser that is similar to a browser operating on the computing device.

5. The system of claim 1, further comprising a data store for storing recorded data related to the browsing behavior replicated by the emulation.

6. The system of claim 1, wherein the replicated browsing behavior comprises downloading electronic files from a web page.

7. The system of claim 6, further comprising a data store for storing the downloaded electronic files.

8. The system of claim 1, wherein the alert includes at least one of a source IP address of a web page, a URL of a web page, a time the undesired modification was detected, a binary file received by the emulation, an identifier of the undesired modification detected on the emulation, and a configuration of the emulation.

9. The system of claim 1, wherein the server is in communication with a local network containing a plurality of computing devices, and, upon detecting an undesired modification, the server automatically generates a network policy to apply to the plurality of computing devices on the local network, wherein the network policy is related to a browsing behavior that caused the undesired modification.

10. The system of claim 1, wherein the server is in communication with a local network containing a plurality of computing devices and, upon detecting an undesired modification, the server is configured to initiate at least one of restoring the computing device to a previous setting, blocking at least one other computing device from accessing a web page that caused the undesired modification, sending a notification to a system administrator, and sending a notification to network users.

11. The system of claim 1, wherein the emulation is further configured for:
identifying on a first web page being browsed by the computing device a link to digital content which the computing device has not accessed;
activating, using a browser on the emulation, the link;
detecting an undesired modification to the emulation caused by the activation of the link; and
automatically generating, upon detecting an undesired modification, an alert containing data related to the link.

12. The system of claim 11, wherein the server is further configured for preventing the computing device from activating the link.

13. The system of claim 1, wherein the computing device is a mobile device.

14. The system of claim 13, wherein the mobile device is configured to automatically forward data indicative of browsing behavior to the server.

15. The system of claim 1, wherein the server is configured to simultaneously execute multiple emulations with different configuration parameters used by different computing devices on a network.

16. The system of claim 15, wherein the server is further configured for:
executing a first emulation of a first computing device and a second emulation of a second computing device, wherein at least one configuration parameter of the first emulation is different from at least one configuration parameter of the second emulation;
receiving, from the first computing device, data related to browsing behavior of the first computing device;
replicating, on the second emulation, the browsing behavior of the first computing device; and
detecting an undesired modification to the second emulation caused by the replicated browsing behavior.

17. The system of claim 1, wherein the server has an Internet connection and the emulation is configured for browsing web pages over the Internet connection.

18. The system of claim 1, wherein the emulation receives cached files from the computing device, and the emulation is configured to browse the cached files.

19. The system of claim 1, wherein the computing device is connected to a network through an intermediate network device, the intermediate network device is in communication with the server, and the server receives the data related to browsing behavior of the computing device via the intermediate network device.

20. A method for detecting an undesired modification to a computing device configured to browse the Internet comprising:
receiving by a server data indicative of a configuration parameter of the computing device in communication with the server;
executing by the server an emulation of the computing device, wherein the emulation emulates the configuration parameter of the computing device;
receiving by the emulation data related to browsing behavior of the computing device;
replicating with the emulation the browsing behavior of the computing device;
detecting by the server an undesired modification to the emulation of the computing device caused by the replicated browsing behavior; and
automatically generating and outputting by the server, upon detecting an undesired modification, an alert containing data related to the undesired modification and related browsing behavior.

21. The method of claim 20, wherein the emulation comprises a virtual machine.

22. The method of claim 21, further comprising selecting by the server a virtual machine with appropriate configuration parameters for emulating the computing device.

23. The method of claim 20, further comprising replicating by emulation of the computing device the browsing behavior of the computing device using a web browser that is similar to a browser operating on the computing device.

24. The method of claim 20, further comprising storing, in a data store, recorded data related to the browsing behavior replicated by the emulation.

25. The method of claim 20, wherein replicating the browsing behavior comprises downloading electronic files from a web page.

26. The method of claim 25, further comprising storing in a data store the downloaded electronic files.

27. The method of claim 20, wherein the alert includes at least one of a source IP address of a web page, a URL of a web page, a time the undesired modification was detected, a binary file received by the emulation, an identifier of the undesired modification detected on the emulation, and a configuration of the emulation.

28. The method of claim 20, wherein the server is in communication with a local network containing a plurality of computing devices, and, upon detecting an undesired modification, further comprising automatically generating by the server a network policy to apply to the plurality of computing devices on the local network, wherein the network policy is related to a browsing behavior that caused the undesired modification.

29. The method of claim 20, wherein the server is in communication with a local network containing a plurality of computing devices and, upon detecting an undesired modification, initiating by the server at least one of restoring the computing device to a previous setting, blocking at least one other computing device from accessing a web page that caused the undesired modification, sending a notification to a system administrator, and sending a notification to network users.

30. The method of claim 20, further comprising:
identifying, by the emulation, on a first web page being browsed by the computing device, a link to which the computing device has not accessed;
activating, using a browser on the emulation, the link;
detecting by the server an undesired modification to the emulation caused by the activation of the link; and
automatically generating by the server, upon detecting an undesired modification, an alert containing data related to the link.

31. The method of claim 30, further comprising preventing the computing device from activating the link.

32. The method of claim 20, wherein the computing device is a mobile device.

33. The method of claim 32, further comprising automatically forwarding by the mobile device data indicative of browsing behavior to the server.

34. The method of claim 20, further comprising simultaneously executing multiple emulations with different configuration parameters used by different computing devices on a network.

35. The method of claim 34, further comprising:
executing, on the server, a first emulation of a first computing device and a second emulation of a second computing device, wherein at least one configuration parameter of the first emulation is different from at least one configuration parameter of the second emulation;
receiving, from the first computing device, data related to browsing behavior of the first computing device;
replicating, on the second emulation, the browsing behavior of the first computing device; and
detecting by the server an undesired modification to the second emulation caused by the replicated browsing behavior.

36. The method of claim 20, wherein the server has an Internet connection, and further comprising browsing, by the emulation, web pages over the Internet connection.

37. The method of claim 20, further comprising:
receiving, by the emulation, cached files from the computing device; and
browsing, by the emulation, the cached files.

38. The method of claim 20, wherein the computing device is connected to a network through a intermediate network device and the intermediate network device is in communication with the server, and further comprising receiving by the server the data related to browsing behavior of the computing device via the intermediate network device.

39. A non-transitory computer readable medium having stored therein instructions for, upon execution, causing a server to implement a method for detecting an undesired modification to a computing device configured to browse the Internet, the method comprising:
receiving by a server data indicative of a configuration parameter of the computing device in communication with the server;
executing by the server an emulation of the computing device, wherein the emulation emulates the configuration parameter of the computing device;
receiving by the emulation data related to browsing behavior of the computing device;
replicating with the emulation the browsing behavior of the computing device;
detecting by the server an undesired modification to the emulation of the computing device caused by the replicated browsing behavior; and
automatically generating and outputting by the server, upon detecting an undesired modification, an alert containing data related to the undesired modification and related browsing behavior.
